(19) United States
(12) Patent Application Publication
(10) Pub. No.: US 2025/0118854 A1
(43) Pub. Date: Apr. 10, 2025

(54) BATTERY PACK

(71) Applicant: Prime Planet Energy & Solutions, Inc., Tokyo (JP)

(72) Inventors: Shun WATANABE, Kasai-shi (JP); Mitsutoshi TAJIMA, Kobe-shi (JP); Yasuaki UEMURA, Kakogawa-shi (JP)

(21) Appl. No.: 18/827,848

(22) Filed: Sep. 9, 2024

(30) Foreign Application Priority Data
Oct. 10, 2023 (JP) 2023-175192

(51) Int. Cl. H01M 50/342; H01M 10/6556; H01M 10/6568; H01M 50/209; H01M 50/224; H01M 50/293; H01M 50/30; H01M 50/367

(52) U.S. Cl. CPC H01M 50/3425; H01M 10/6556; H01M 10/6568; H01M 50/209; H01M 50/224; H01M 50/293; H01M 50/367; H01M 50/394; H01M 2200/20

(57) ABSTRACT

A battery pack includes: a plurality of battery cells; and a case having a first space that accommodates the plurality of battery cells, wherein the case includes a main body having a bottom surface, and a bottom surface cover facing the bottom surface of the main body from outside, the main body and the bottom surface cover are fastened to each other at a plurality of fastening portions including a first fastening portion and a second fastening portion, and the main body is provided with a recess facing the bottom surface cover, a second space is formed between the recess and the bottom surface cover, and the second space communicates with the first space, the case is provided with an opening through which the second space and outside of the case communicate with each other, and the opening is located between the first fastening portion and the second fastening portion.

### CROSS REFERENCE TO RELATED APPLICATIONS

This nonprovisional application is based on Japanese Patent Application No. 2023-175192 filed on Oct. 10, 2023 with the Japan Patent Office, the entire contents of which are hereby incorporated by reference.

### BACKGROUND OF THE INVENTION

### Field of the Invention

The present technology relates to a battery pack.

### Description of the Background Art

Conventionally, a battery pack having a case in which a gas-discharge path is provided has been known. As the prior art, there are Japanese National Patent Publication No. 2022-510652, Japanese Patent Laying-Open No. 2023-124435, and Japanese Patent Laying-Open No. 2023-124436.

### SUMMARY OF THE INVENTION

From the viewpoint of suppressing deformation of the case at the time of discharging of gas while suppressing its structure from being complicated, there is still room for improvement in the conventional battery pack.

An object of the present technology is to provide a battery pack so as to suppress deformation of a case at the time of discharging of gas by a simple structure.

The present technology provides the following battery pack.

[1] A battery pack comprising: a plurality of battery cells; and a case having a first space that accommodates the plurality of battery cells, wherein the case includes a main body having a bottom surface, and a bottom surface cover facing the bottom surface of the main body from outside, the main body and the bottom surface cover are fastened to each other at a plurality of fastening portions including a first fastening portion and a second fastening portion, the main body is provided with a recess facing the bottom surface cover, a second space is formed between the recess and the bottom surface cover, and the second space communicates with the first space, and the case is provided with an opening through which the second space and outside of the case communicate with each other, and the opening is located between the first fastening portion and the second fastening portion.

[2] The battery pack according to [1], wherein the main body is constituted of a cast component.

[3] The battery pack according to [1] or [2], wherein the bottom surface cover is constituted of a plate-shaped member.

[4] The battery pack according to [1] or [2], wherein the bottom surface cover is provided with another recess facing the recess of the main body.

[5] The battery pack according to any one of [1] to [4], further comprising a membrane member provided to close a communication portion between the first space and the second space, the membrane member having air permeability.

[6] The battery pack according to [5], wherein the membrane member opens the communication portion when a pressure of the first space exceeds a predetermined pressure.

[7] The battery pack according to any one of [1] to [6], wherein a third space for a coolant path is formed between the bottom surface of the main body and the bottom surface cover.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a battery pack.

FIG. 2 is a perspective view of a battery assembly included in the battery pack.

FIG. 3 is a perspective view of a battery cell included in the battery assembly.

FIG. 4 is a bottom view of a case main body of the battery pack.

FIG. 5 is a cross sectional view along V-V in FIG. 4.

FIG. 6 is a perspective view showing the vicinity of an opening of a duct.

FIG. 7 is a cross sectional view along VII-VII in FIG. 6.

FIG. 8 is a diagram showing a bottom surface of the case main body so as to show surroundings of the duct.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium ion battery. In the present specification, the term “electrode” may collectively represent a positive electrode and a negative electrode.

In the present specification, the term “battery cell” is not necessarily limited to a prismatic battery cell and may include a cell having another shape, such as a cylindrical battery cell, a pouch battery cell, or a blade battery cell. The “battery cell” can be mounted on vehicles such as a hybrid electric vehicle (HEV), a plug-in hybrid electric vehicle (PHEV), and a battery electric vehicle (BEV). It should be noted that the use of the “battery cell” is not limited to the use in a vehicle.

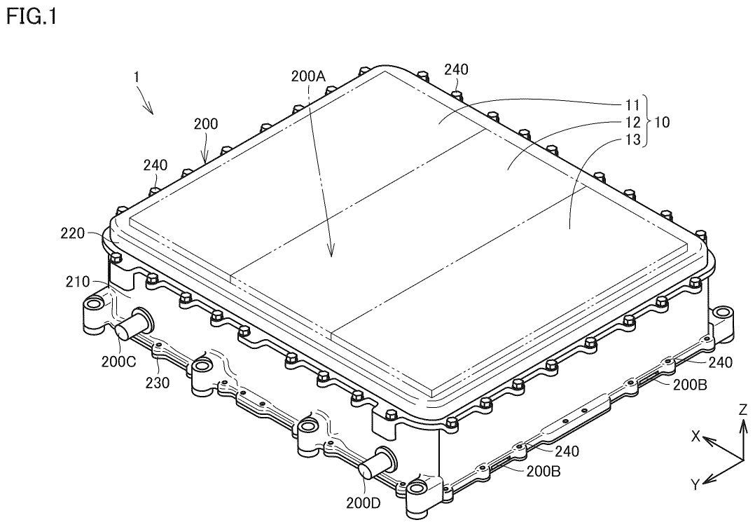

FIG. 1 is a perspective view of a battery pack according to the present embodiment. As shown in FIG. 1, a battery pack 1 includes a case 200. Battery assemblies 10 are accommodated in an inner space 200A (first space) of case 200.

In the example of FIG. 1, battery assemblies 10 include three battery assemblies 11, 12, 13. Battery assembly 11 (first stack), battery assembly 12 (second stack), and battery assembly 13 (third stack) each include a plurality of battery cells arranged side by side in the Y axis direction (first direction), and are arranged side by side in the X axis direction (second direction).

Case 200 includes a main body 210, an upper cover 220, and a bottom surface cover 230. Main body 210 and each of upper cover 220 and bottom surface cover 230 are fastened to each other at a plurality of fastening portions 240 each constituted of a bolt or the like.

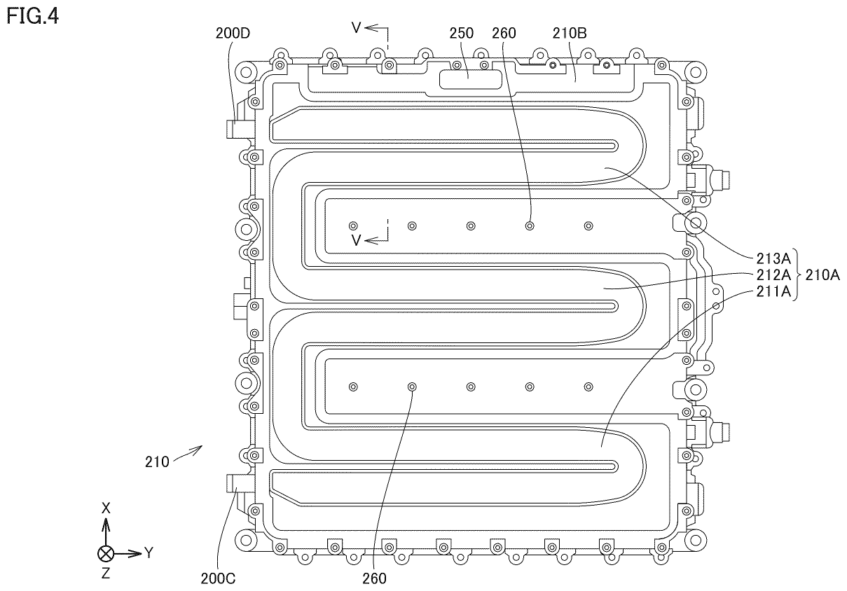

Main body 210 and upper cover 220 form inner space 200A of case 200. Each of a below-described coolant path 210A and a below-described gas-discharge duct 210B (see FIGS. 4 and 5) is formed between the bottom surface of main body 210 and bottom surface cover 230.

As shown in FIG. 1, case 200 is provided with: an opening 200B through which gas-discharge duct 210B communicates with outside of case 200; an inlet portion 200C for a coolant to coolant path 210A; and an outlet portion 200D for the coolant from coolant path 210A.

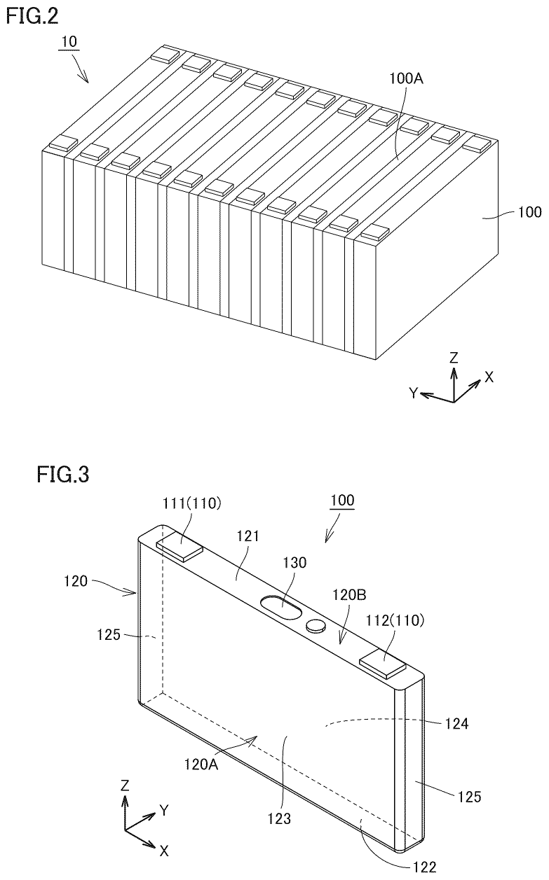

FIG. 2 is a perspective view of each battery assembly 10. Battery assembly 10 shown in FIG. 2 includes battery cells 100 and insulating members 100A (inter-cell separators). Battery cells 100 and insulating members 100A are alternately arranged along the Y axis direction (first direction).

The plurality of battery cells 100 are battery cells each having a prismatic shape, and are provided along the Y axis direction. The plurality of battery cells 100 are electrically connected together by a bus bar (not shown).

Insulating members 100A are provided between the plurality of battery cells 100. Each of insulating members 100A prevents unintended electrical conduction between adjacent battery cells 100. Insulating member 100A secures an electrical insulation property between adjacent battery cells 100.

Battery assembly 10 is accommodated in case 200, thereby forming battery pack 1 shown in FIG. 1. Battery pack 1 may have a structure (Cell-to-Pack structure) in which the wall surface of case 200 directly supports the stack of battery cells 100 and insulating members 100A, or may have a structure (Cell-Module-Pack structure) in which a battery module including the plurality of battery cells 100 and insulating members 100A is accommodated in case 200.

FIG. 3 is a perspective view showing each battery cell 100. As shown in FIG. 3, battery cell 100 has a prismatic shape. Battery cell 100 has electrode terminals 110, a battery case 120, and a gas-discharge valve 130.

Each of electrode terminals 110 is formed on battery case 120. Electrode terminals 110 have a positive electrode terminal 111 and a negative electrode terminal 112 arranged side by side along the X axis direction (second direction) orthogonal to the Y axis direction (first direction). Positive electrode terminal 111 and negative electrode terminal 112 are provided to be separated from each other in the X axis direction.

Battery case 120 has a rectangular parallelepiped shape and forms an external appearance of battery cell 100. Battery case 120 includes: a case main body 120A that accommodates an electrode assembly (not shown) and an electrolyte solution (not shown); and a sealing plate 120B that seals an opening of case main body 120A. Sealing plate 120B is joined to case body 120A by welding.

Battery case 120 has an upper surface 121, a lower surface 122, a first side surface 123, a second side surface 124, and two third side surfaces 125.

Upper surface 121 is a flat surface orthogonal to the Z axis direction (third direction) orthogonal to the Y axis direction and the X axis direction. Electrode terminals 110 are disposed on upper surface 121. Lower surface 122 faces upper surface 121 along the Z axis direction.

Each of first side surface 123 and second side surface 124 is constituted of a flat surface orthogonal to the Y axis direction. Each of first side surface 123 and second side surface 124 has the largest area among the areas of the plurality of side surfaces of battery case 120. Each of first side surface 123 and second side surface 124 has a rectangular shape when viewed in the Y axis direction. Each of first side surface 123 and second side surface 124 has a rectangular shape in which the X axis direction corresponds to the long-side direction and the Z axis direction corresponds to the short-side direction when viewed in the Y axis direction.

The plurality of battery cells 100 are stacked such that first side surfaces 123 of battery cells 100, 100 adjacent to each other in the Y direction face each other and second side surfaces 124 of battery cells 100, 100 adjacent to each other in the Y axis direction face each other. Thus, positive electrode terminals 111 and negative electrode terminals 112 are alternately arranged in the Y axis direction in which the plurality of battery cells 100 are stacked.

Gas-discharge valve 130 is provided in upper surface 121. When the temperature of battery cell 100 is increased (thermal runaway) and internal pressure of battery case 120 becomes more than or equal to a predetermined value due to gas generated inside battery case 120, gas-discharge valve 130 discharges the gas to outside of battery case 120.

FIG. 4 is a bottom view of main body 210 of case 200, and FIG. 5 is a cross sectional view along V-V in FIG. 4.

As shown in FIGS. 4 and 5, main body 210 is provided with a recess facing bottom surface cover 230, and this recess constitutes coolant path 210A and gas-discharge duct 210B.

Main body 210 is a cast component composed of a metal such as aluminum, for example. Each of upper cover 220 and bottom surface cover 230 is a plate-shaped member composed of a metal such as aluminum, for example. It should be noted that bottom surface cover 230 may be constituted of a cast component and may be provided with another recess facing the recess of main body 210 so as to form coolant path 210A and gas-discharge duct 210B by combining the two recesses facing each other.

Coolant path 210A (third space) is formed between the bottom surface of main body 210 and bottom surface cover 230. Coolant path 210A is formed directly below each of battery assemblies 11, 12, 13 so as to extend in the Y axis direction. In the example of FIG. 4, a first portion 211A is formed directly below battery assembly 11, a second portion 212A is formed directly below battery assembly 12, and a third portion 213A is formed directly below battery assembly 13. The coolant having flowed from inlet portion 200C into coolant path 210A flows through first portion 211A, then flows through second portion 212A, further flows through third portion 213A, and then flows to the outside of case 200 from outlet portion 200D. Since the coolant (for example, water) flows directly below battery assemblies 11, 12, 13, cooling of battery cells 100 is promoted.

Gas-discharge duct 210B (second space) serving as a gas-discharge path is formed between the bottom surface of main body 210 and bottom surface cover 230. Gas-discharge duct 210B communicates with inner space 200A of case 200, and also communicates with the outside of case 200 through opening 200B. A breathable membrane 250 (membrane member) having air permeability is provided to close the communication portion between inner space 200A of case 200 and gas-discharge duct 210B. When the pressure of inner space 200A does not exceed a predetermined pressure, breathable membrane 250 permits an air component to pass therethrough and suppresses moisture from entering inner space 200A. When the pressure of inner space 200A exceeds the predetermined pressure (when the pressure is increased abnormally), breathable membrane 250 is broken to open the communication portion between inner space 200A and gas-discharge duct 210B, thereby promoting discharging of gas or the like from inner space 200A.

Main body 210 and bottom surface cover 230 are fastened to each other also at fastening portions 260 provided between first portion 211A and second portion 212A and between second portion 212A and third portion 213A. In other words, coolant path 210A extends in the Y axis direction on both sides with respect to fastening portions 260 in the X axis direction.

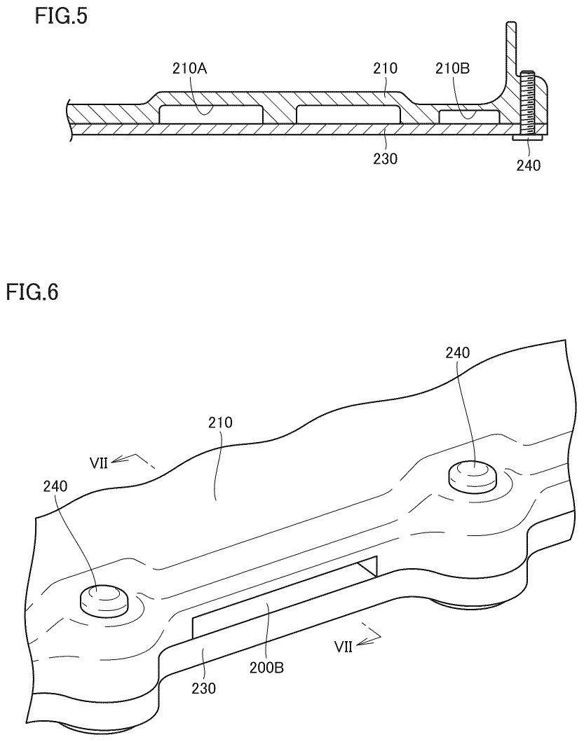

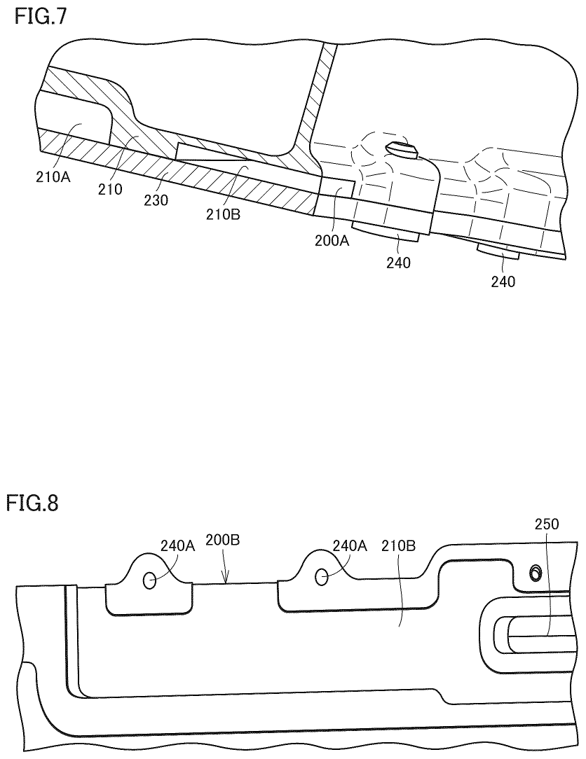

FIG. 6 is a perspective view showing the vicinity of opening 200B of gas-discharge duct 210B, and FIG. 7 is a cross sectional view along VII-VII in FIG. 6. FIG. 8 is a diagram showing the bottom surface of main body 210 so as to show surroundings of gas-discharge duct 210B.

As shown in FIGS. 6 to 8, opening 200B of gas-discharge duct 210B is located between two fastening portions 240 (a first fastening portion and a second fastening portion). When the pressure of inner space 200A of case 200 is increased to discharge the gas or the like through gas-discharge duct 210B, case 200 (bottom surface cover 230) needs to be suppressed from being deformed around opening 200B to cause discharging of the gas or the like from an unintended portion thereof. On other hand, from the viewpoint of reduced manufacturing cost, space saving when mounted on a vehicle, and the like, it is also required to suppress the structure of case 200 from being complicated.

In battery pack 1 according to the present embodiment, since there is employed the structure in which opening 200B of gas-discharge duct 210B is provided between two fastening portions 240 as described above, case 200 can be suppressed from being deformed to discharge the gas or the like from an unintended position thereof while suppressing an increase in the number of components.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery pack comprising:
a plurality of battery cells; and
a case having a first space that accommodates the plurality of battery cells, wherein
the case includes a main body having a bottom surface, and a bottom surface cover facing the bottom surface of the main body from outside,
the main body and the bottom surface cover are fastened to each other at a plurality of fastening portions including a first fastening portion and a second fastening portion,
the main body is provided with a recess facing the bottom surface cover, a second space is formed between the recess and the bottom surface cover, and the second space communicates with the first space, and
the case is provided with an opening through which the second space and outside of the case communicate with each other, and the opening is located between the first fastening portion and the second fastening portion.

2. The battery pack according to claim 1, wherein the main body is constituted of a cast component.

3. The battery pack according to claim 1, wherein the bottom surface cover is constituted of a plate-shaped member.

4. The battery pack according to claim 1, wherein
the main body is constituted of a cast component, and
the bottom surface cover is constituted of a plate-shaped member.

5. The battery pack according to claim 1, wherein the bottom surface cover is provided with another recess facing the recess of the main body.

6. The battery pack according to claim 1, wherein
the main body is constituted of a cast component, and
the bottom surface cover is provided with another recess facing the recess of the main body.

7. The battery pack according to claim 1, further comprising a membrane member provided to close a communication portion between the first space and the second space, the membrane member having air permeability.

8. The battery pack according to claim 7, wherein the membrane member opens the communication portion when a pressure of the first space exceeds a predetermined pressure.

9. The battery pack according to claim 1, wherein the main body is constituted of a cast component,
the battery pack further comprising a membrane member provided to close a communication portion between the first space and the second space, the membrane member having air permeability.

10. The battery pack according to claim 1, wherein the bottom surface cover is constituted of a plate-shaped member,
the battery pack further comprising a membrane member provided to close a communication portion between the first space and the second space, the membrane member having air permeability.

11. The battery pack according to claim 1, wherein the bottom surface cover is provided with another recess facing the recess of the main body,
the battery pack further comprising a membrane member provided to close a communication portion between the first space and the second space, the membrane member having air permeability.

12. The battery pack according to claim 1, wherein the main body is constituted of a cast component,
the battery pack further comprising a membrane member provided to close a communication portion between the first space and the second space, the membrane member having air permeability, wherein
the membrane member opens the communication portion when a pressure of the first space exceeds a predetermined pressure.

13. The battery pack according to claim 1, wherein the bottom surface cover is constituted of a plate-shaped member,
the battery pack further comprising a membrane member provided to close a communication portion between the first space and the second space, the membrane member having air permeability, wherein
the membrane member opens the communication portion when a pressure of the first space exceeds a predetermined pressure.

14. The battery pack according to claim 1, wherein the bottom surface cover is provided with another recess facing the recess of the main body,
the battery pack further comprising a membrane member provided to close a communication portion between the first space and the second space, the membrane member having air permeability, wherein
the membrane member opens the communication portion when a pressure of the first space exceeds a predetermined pressure.

15. The battery pack according to claim 1, wherein a third space for a coolant path is formed between the bottom surface of the main body and the bottom surface cover.

16. The battery pack according to claim 1, wherein the main body is constituted of a cast component,
the battery pack further comprising a membrane member provided to close a communication portion between the first space and the second space, the membrane member having air permeability, wherein
the membrane member opens the communication portion when a pressure of the first space exceeds a predetermined pressure, and
a third space for a coolant path is formed between the bottom surface of the main body and the bottom surface cover.
